(19) United States
(12) Patent Application Publication
(10) Pub. No.: US 2025/0140276 A1
(43) Pub. Date: May 1, 2025

(54) SPEAKER SEPARATION METHOD AND DEVICE

(71) Applicant: 42dot Inc., Seoul (KR)

(72) Inventors: Younglo LEE, Seongnam-si (KR); Shukjae CHOI, Seongnam-si (KR); Byeongyeol KIM, Seongnam-si (KR)

(73) Assignee: 42dot Inc., Seoul (KR)

(21) Appl. No.: 18/928,934

(22) Filed: Oct. 28, 2024

Related U.S. Application Data
(60) Provisional application No. 63/593,950, filed on Oct. 27, 2023.

(30) Foreign Application Priority Data
Oct. 28, 2024 (KR) 10-2024-0148345

(51) Int. Cl. G10L 21/0272; G10L 13/02

(52) U.S. Cl. CPC G10L 21/0272; G10L 13/02

(57) ABSTRACT

Provided are a speaker separation method and device. A speaker separation method for separating an unknown number of speakers from a recorded mixture signal based on an encoder-decoder separation model, including: mapping the mixture signal to an N-dimensional latent representation using an encoder of the encoder-decoder separation model; inputting the N-dimensional latent representation into a separator of the encoder-decoder separation model, wherein the separator includes a dual-path processing block for modeling spectrotemporal patterns, a transformer decoder-based attractor (TDA) calculation module for handling an unknown number of speakers, and a triple-path processing block for modeling inter-speaker relations; performing speaker estimation for speaker separation using the separator to obtain source representations corresponding to the number of separated speakers; and outputting an audio signal for each source representation corresponding to the number of separated speakers using a decoder of the encoder-decoder separation model.

### CROSS-REFERENCE TO RELATED APPLICATION

This application claims priority to and the benefit of U.S. Provisional Patent Application No. 63/593,950 filed on Oct. 27, 2023 and Korean Patent Application No. 10-2024-0148345 filed on Oct. 28, 2024, the entire contents of which are incorporated herein by reference.

### BACKGROUND

### (a) Field

The present disclosure relates to a speaker separation method and device.

### (b) Description of the Related Art

Speech separation refers to the task of separating individual speech signals from a mixture signal recorded when multiple speakers are talking simultaneously. For example, in situations where several speakers are talking at the same time, accurately separating each speaker's speech is essential for improving the performance of speech recognition systems. While humans can recognize specific sounds of interest from a mixture signal containing multiple sound sources, existing technologies generally require stereo or multi-channel audio, and their performance in speaker separation declines sharply when dealing with single-channel speech signals. Therefore, researchers are continuously exploring solutions to achieve high-quality speech separation under the condition of a single-channel audio input.

### SUMMARY

The present disclosure attempts to provide a speaker separation method and device that can separate an unknown number of speakers from a recorded mixture signal based on an encoder-decoder separation model.

According to an embodiment, provided is a speaker separation method, performed by a computing device including a processor and a storage medium, for separating an unknown number of speakers from a recorded mixture signal based on an encoder-decoder separation model, the method including: mapping, by the processor, the mixture signal to an N-dimensional latent representation (where N is an integer greater than or equal to 2) using an encoder of the encoder-decoder separation model; inputting, by the processor, the N-dimensional latent representation into a separator of the encoder-decoder separation model, wherein the separator includes a dual-path processing block for modeling spectrotemporal patterns, a transformer decoder-based attractor (TDA) calculation module for handling an unknown number of speakers, and a triple-path processing block for modeling inter-speaker relations; performing, by the processor, speaker estimation for speaker separation using the separator to obtain source representations corresponding to the number of separated speakers; and outputting, by the processor, an audio signal for each source representation corresponding to the number of separated speakers using a decoder of the encoder-decoder separation model.

The encoder may include a one-dimensional convolutional layer with a kernel size of L samples (where L is an integer greater than or equal to 1) and a stride size of L/2 samples, and the mapping may include mapping, by the processor, the mixture signal to the N-dimensional latent representation using a Gaussian Error Linear Unit (GELU) activation function.

The performing speaker estimation may include: dividing, by the processor, the output of the encoder into multiple chunks using the linear layer and chunking block of the separator; and inputting, by the processor, the multiple chunks into the dual-path processing block as a segmented tensor.

The multiple chunks may include S chunks (where S is a number determined by the file length), each chunk having K frames (where K is an integer greater than or equal to 1).

The dual-path processing block may include an intra-chunk LSTM attention block for intra-chunk processing and an inter-chunk LSTM attention block for inter-chunk processing, and wherein the intra-chunk LSTM attention block and the inter-chunk LSTM attention block each may include an LSTM module (Long Short-Term Memory) and a self-attention module.

The performing speaker estimation may include: inputting, by the processor, the output of the dual-path processing block into an overlap-add block to perform form restoration; inputting, by the processor, the output of the overlap-add block into the TDA calculation module to extract a number of attractors that is one more than the number of speakers; passing, by the processor, the attractors through the linear layer of the TDA calculation module to estimate the speaker existence probability; and after excluding the attractors determined not to correspond to any speaker based on the speaker existence probability estimation, inputting, by the processor, the remaining attractors into a FILM (Feature-wise Linear Modulation) module to expand the speaker channels.

The TDA calculation module may include M transformer decoder layers (where M is an integer greater than or equal to 1), and wherein each of the M transformer decoder layers may include a self-attention layer and a cross-attention layer.

The performing speaker estimation may include: integrating, by the processor, the information between speaker queries through the self-attention layer of the transformer decoder layers; and integrating, by the processor, the information between the output of the dual-path processing block and the speaker queries through the cross-attention layer.

The performing speaker estimation may include: refining, by the processor, the output of the FILM (Feature-wise Linear Modulation) module through the triple-path processing block; and inputting, by the processor, the output of the triple-path processing block into the overlap-add block to perform form restoration.

The triple-path processing block may include: an intra-chunk LSTM attention block for intra-chunk processing, an inter-chunk LSTM attention block for inter-chunk processing, and an inter-speaker transformer block for inter-speaker processing.

According to an embodiment, provided is a speaker separation device, executing program code loaded into one or more memory devices through one or more processors, for separating an unknown number of speakers from a recorded mixture signal based on an encoder-decoder separation model, wherein the program code, when executed, performs: mapping the mixture signal to an N-dimensional latent representation (where N is an integer greater than or equal to 2) using an encoder of the encoder-decoder separation model; inputting the N-dimensional latent representation into a separator of the encoder-decoder separation model, wherein the separator includes a dual-path processing block for modeling spectrotemporal patterns, a transformer decoder-based attractor (TDA) calculation module for handling an unknown number of speakers, and a triple-path processing block for modeling inter-speaker relations; performing speaker estimation for speaker separation using the separator to obtain source representations corresponding to the number of separated speakers; and outputting an audio signal for each source representation corresponding to the number of separated speakers using a decoder of the encoder-decoder separation model.

The encoder may include a one-dimensional convolutional layer with a kernel size of L samples (where L is an integer greater than or equal to 1) and a stride size of L/2 samples, and the mapping may include mapping, by the processor, the mixture signal to the N-dimensional latent representation using a Gaussian Error Linear Unit (GELU) activation function.

The performing speaker estimation may include: dividing, by the processor, the output of the encoder into multiple chunks using the linear layer and chunking block of the separator; and inputting, by the processor, the multiple chunks into the dual-path processing block as a segmented tensor.

The multiple chunks may include S chunks (where S is a number determined by the file length), each chunk having K frames (where K is an integer greater than or equal to 1).

The dual-path processing block may include an intra-chunk LSTM attention block for intra-chunk processing and an inter-chunk LSTM attention block for inter-chunk processing, and wherein the intra-chunk LSTM attention block and the inter-chunk LSTM attention block each may include an LSTM module (Long Short-Term Memory) and a self-attention module.

The performing speaker estimation may include: inputting, by the processor, the output of the dual-path processing block into an overlap-add block to perform form restoration; inputting, by the processor, the output of the overlap-add block into the TDA calculation module to extract a number of attractors that is one more than the number of speakers; passing, by the processor, the attractors through the linear layer of the TDA calculation module to estimate the speaker existence probability; and after excluding the attractors determined not to correspond to any speaker based on the speaker existence probability estimation, inputting, by the processor, the remaining attractors into a FILM (Feature-wise Linear Modulation) module to expand the speaker channels.

The TDA calculation module may include M transformer decoder layers (where M is an integer greater than or equal to 1), and wherein each of the M transformer decoder layers may include a self-attention layer and a cross-attention layer.

The performing speaker estimation may include: integrating, by the processor, the information between speaker queries through the self-attention layer of the transformer decoder layers; and integrating, by the processor, the information between the output of the dual-path processing block and the speaker queries through the cross-attention layer.

The performing speaker estimation may include: refining, by the processor, the output of the FILM (Feature-wise Linear Modulation) module through the triple-path processing block; and inputting, by the processor, the output of the triple-path processing block into the overlap-add block to perform form restoration.

The triple-path processing block may include: an intra-chunk LSTM attention block for intra-chunk processing, an inter-chunk LSTM attention block for inter-chunk processing, and an inter-speaker transformer block for inter-speaker processing.

### BRIEF DESCRIPTION OF THE DRAWINGS

FIG. 1 is a block diagram for explaining a speaker separation device according to an embodiment.

FIGS. 2 to 7 are diagrams for explaining implementation examples of the speaker separation device according to an embodiment.

FIG. 8 is a flowchart for explaining a speaker separation method according to an embodiment.

FIG. 9 is a diagram for explaining a computing device according to an embodiment.

### DETAILED DESCRIPTION

Hereinafter, embodiments of the present disclosure are described in detail with reference to the accompanying drawings so that those skilled in the art to which the present disclosure pertains may easily practice the present disclosure. However, the present disclosure may be implemented in various different forms, and is not limited to the embodiments described herein. In addition, in the drawings, portions unrelated to the description are omitted to clearly describe the present disclosure, and similar portions are denoted by similar reference numerals throughout the specification.

Through the specification and claims, unless explicitly described otherwise, “including” any components will be understood to imply the inclusion of another component rather than the exclusion of another component. Terms including ordinal numbers such as “first”, “second”, and the like, may be used to describe various components. However, these components are not limited by these terms. These terms are used only to distinguish one component and another component from each other.

Terms such as “˜part”, “˜er/or”, and “module” described in the specification may refer to a unit capable of processing at least one function or operation described in the specification, which may be implemented as hardware, a circuit, software, or a combination of hardware or circuit and software. In addition, at least some components or functions of a speaker separation method and device for separating an unknown number of speakers from a recorded mixture signal based on an encoder-decoder separation model according to the embodiments described below may be implemented as a program or software, and the program or software may be stored in a computer-readable medium.

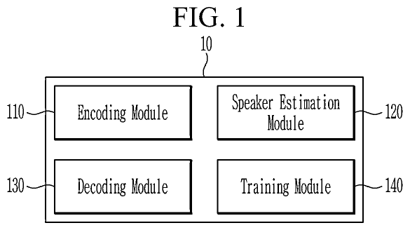

FIG. 1 is a block diagram for explaining a speaker separation device according to an embodiment.

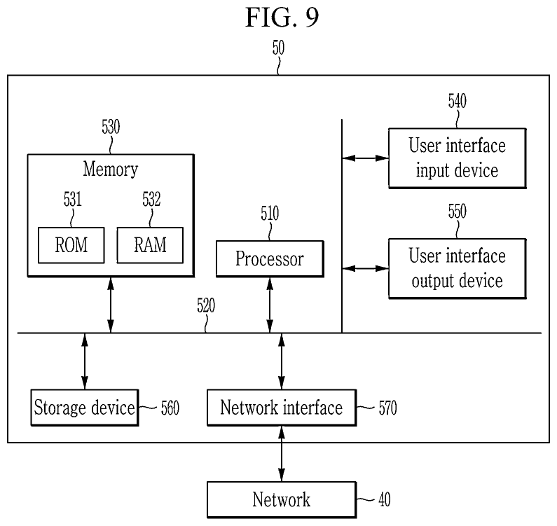

Referring to FIG. 1, a speaker separation device 10 according to an embodiment may execute program code or instructions loaded into one or more memory devices through one or more processors. For example, the speaker separation device 10 may be implemented as a computing device 50, as will be described later in relation to FIG. 9. In this case, the one or more processors correspond to the processor 510 of the computing device 50, and the one or more memory devices correspond to the memory 520 of the computing device 50. The program code or instructions may be executed by the one or more processors to perform multiple text and speech-related tasks using an integrated decoder model. In this specification, the term “module” is used to logically distinguish functions performed by the program code or instructions.

The speaker separation device 10 may utilize a speech separation model that combines the strengths of a triple-path approach and an LSTM-augmented self-attention block or LSTM-attention, enabling more efficient capture of both local and global contextual information. Additionally, the speaker separation device 10 may adopt a transformer decoder-based attractor (TDA) computation module to effectively handle cases where the number of speakers is unknown. Specifically, the speaker separation device 10 may include all or at least some of the following: an encoding module 110, a speaker estimation module 120, a decoding module 130, and a training module 140. For example, the training module 140 may be implemented within the speaker separation device 10. Alternatively, the training module 140 may be implemented externally, and the speaker separation device 10 may receive the trained encoder-decoder separation model from the training module 140.

The encoding module 110 may map the mixture signal x to an N-dimensional latent representation (where N is an integer greater than or equal to 2) using the encoder of the encoder-decoder separation model, which has been trained by the training module 140. Here, the encoder-decoder separation model may be implemented as a time domain encoder-decoder separation framework. When the mixture signal x in the time domain, consisting of T samples, includes C speakers (where C is an integer greater than or equal to 2), the separation model may be trained to estimate the source y_{c} for each speaker. For example, T may be determined as 16,000 samples for 1 second if the sampling rate is 16,000. Here, the mixture signal x may be represented as follows.

$$x = {\sum }_{c = 1}^{C} {y}_{c} ∈ {ℝ}^{T}$$

In some embodiments, the encoder may include a one-dimensional convolutional layer with a kernel size of L samples (where L is an integer greater than or equal to 1) and a stride size of L/2 samples. The encoder may map the mixture signal x to an N-dimensional latent representation E (also referred to as a Dₑ-dimensional representation). Here, E may be represented as follows:

$$E = GELU ( Conv 1 D ( x ) ) ∈ {ℝ}^{{T}^{′} \times {D}_{e}}$$

Here, T′ is [2× T/L], and appropriate zero-padding may be applied. In some embodiments, as indicated by GELU ( ) in the formula, the encoder may perform the mapping using a Gaussian Error Linear Unit (GELU) activation function.

The speaker estimation module 120 may input the N-dimensional latent representation into the separator of the encoder-decoder separation model. Here, the separator may include a dual-path processing block for modeling spectrotemporal patterns, a transformer decoder-based attractor (TDA) calculation module for handling an unknown number of speakers, and a triple-path processing block for modeling inter-speaker relations. The speaker estimation module 120 may perform speaker estimation for speaker separation using the separator to obtain source representations corresponding to the number of separated speakers.

The separator may take the encoder output E as input and generate C source representations Z_{c}∈ [symbol] ^{T′×D}^{ₑ}, where c∈{1, . . . , C}. First, E is input into a linear layer with an output unit size of D, and then it may be divided into chunks of K frames with a hop size of [K/2]. This operation can generate S chunks U^{s}∈ [symbol] ^{K×D}, where s∈{1, . . . , S}. All chunks are stacked along a new chunk axis, and a 3D tensor U∈ [symbol] ^{K×S×D} may be generated.

The dual-path processing block receives the segmented tensor U as input and performs the processing represented by the following mathematical expression to output U″.

$${U}^{′} = [ {f}_{intra} ( U [ : , s , : ] ) , ∀ s ] ∈ {ℝ}^{K \times S \times D}$$

$${U}^{″} = LN ( [ {f}_{inter} ( {U}^{′} [ k , : , : ] ) , ∀ k ] + U )$$

Here, k∈{1, . . . , K}, and fᵢₙₜᵣₐ( ), fᵢₙₜₑᵣ( ), and LN( ) may represent intra-chunk processing, inter-chunk processing, and layer normalization, respectively. In the case of fᵢₙₜᵣₐ( ) and fᵢₙₜₑᵣ( ) an LSTM-augmented architecture, specifically an intra-chunk LSTM-attention block, may be introduced. This allows for direct context-awareness, enabling more efficient capture of both local and global contextual information.

The TDA calculation module may include M transformer decoder layers (where M is an integer greater than or equal to 1). During training, assuming that the number of speakers C is known, C+1 speaker query embeddings Q∈ [symbol] ^{(C+1)×D} are randomly initialized and can be learned through the training process. The TDA calculation module may estimate the attractor A based on the speaker queries Q and the mixture context as follows.

$$A = TDA ( OverlapAdd ( {U}^{″} ) ) ∈ {ℝ}^{( C + 1 ) \times D}$$

The context may be obtained by performing an overlap-add operation on the output U″ of the dual-path processing block and can be utilized as context in the cross-attention calculation. This enables attention over the entire sequence of length T′, and each speaker query can be transformed into a speaker-wise attractor. Since C is much smaller than T′, the cross-attention operation has low complexity.

The TDA calculation module adopts masked self-attention to prevent the attention of the c-th attractor prediction from focusing on speaker queries beyond c (i.e., >c). The first C attractors are responsible for speaker identification, while the (C+1)-th attractor may be used to estimate the nonexistence of a speaker. The self-attention operation may be omitted in the first decoder layer. After the TDA calculation, the C speaker-wise attractors are combined with the output U″ of the dual-path processing block through feature-wise linear modulation (FILM) conditioning, resulting in a 4D tensor output V₀, as follows.

$$A [ : C ] = [ {a}_{1} , … , {a}_{C} ] ∈ {ℝ}^{C \times D}$$

$${V}_{0} = FiLM ( {U}^{″} , A [ : C ] ) ∈ {ℝ}^{C \times K \times S \times D}$$

Here, FiLM(F,d)=Linear(d)⊙F+Linear′(d), meaning that two different linear projections are applied to d, where ⊙ represents element-wise multiplication.

The tensor V₀ may be refined by N triple-path processing blocks. Each triple-path processing block may include an intra-chunk LSTM-attention block for intra-chunk processing, an inter-chunk LSTM-attention block for inter-chunk processing, and an inter-speaker transformer block for inter-speaker processing. The triple-path processing block may be expressed as follows.

$${V}_{n - 1}^{′} = [ {f}_{n , intra} ( {V}_{n - 1} [ c , : , s , : ] ) , ∀ c , s ]$$

$${V}_{n - 1}^{″} = [ {f}_{n , inter} ( {V}_{n - 1}^{′} [ c , k , : , : ] ) , ∀ c , k ]$$

$${V}_{n} = LN ( [ {f}_{n , speaker} ( {V}_{n - 1}^{″} [ c , : , : , : ] ) , ∀ c ] + {V}_{n - 1} )$$

Here, c∈{1, . . . , C}, and f_{n,intra}( ) f_{n,inter}( ) and f_{n,speaker} may represent intra-chunk processing, inter-chunk processing, and inter-speaker processing in block n∈{1, . . . , N}, respectively.

After the final triple-path processed output V_{N} is generated, an overlap-add operation may be performed on the S chunks. This generates an output with the same sequence length as the encoder output E, having a size of [symbol] ^{C×T′×D}. Subsequently, layer normalization and a feedforward layer with an output unit size of Dₑ may be applied, resulting in Z_{N,c}∈ [symbol] ^{T′×D}^{ₑ}.

The decoding module 130 may output an audio signal for each source representation corresponding to the number of separated speakers using a decoder. In some embodiments, the decoder may use a transposed convolution version of the encoder (i.e., with a kernel size of L samples and a stride size of L/2 samples) to reconstruct each source waveform ŷ_{c} from Z_{N,c}.

$${\hat{y}}_{N , c} = TransposedConv 1 D ( {Z}_{N , c} )$$

The training module 140 may introduce multi-scale loss for training the encoder-decoder separation model. The reconstruction loss may be computed from the output Vₙ of each triple-path processing block. Then, the average across all triple-path blocks may be used as the loss. The reconstruction loss may be defined as the Scale-Invariant Signal-to-Distortion Ratio (SI-SDR) as follows.

$${ℒ}_{recon} = - \frac{1}{N} {\sum }_{n = 1}^{N} {max}_{π ∈ {\prod }_{C}} \frac{1}{C} {\sum }_{c = 1}^{C} SI - SDR ( {y}_{c} , {\hat{y}}_{n , π ( c )} )$$

Here, N is the number of triple-path blocks, and I′lc represents the set of all permutations for C speakers, where utterance-level Permutation Invariant Training (PIT) is used to solve the label-permutation problem. The label-permutation problem includes scenarios where, for example, if there are 3 speakers, the order may be 123, 132, 213, 231, 321, or 312. ŷ_{N,c} is the estimated result of the c-th source obtained from the output of the n-th triple-path processing block.

Meanwhile, the training objective for the attractor existence probability may be based on binary cross-entropy, as follows.

[symbol]

_{attractor}=BCE(α,σ(Linear(A)))

Here, A is the set of attractor vectors, α∈[1, . . . ,1,0]^{T}∈ [symbol] ^{C+1}, σ( ) is a sigmoid activation function, and BCE( ) is a binary cross-entropy loss between the target values and the logits. The final loss may be represented as follows.

$${ℒ}_{total} = {ℒ}_{recon} + {ℒ}_{attractor}$$

According to the present embodiment, the described single-channel speech separation model can process a mixture signal with an unknown number of speakers. Meanwhile, with the introduction of the LSTM-attention block, the issues with previous separation models, which could only separate a fixed number of speakers or had poor separation performance with a variable number of speakers, can be improved. Additionally, the TDA calculation module can infer the relationship between the trained set of speaker queries and the mixture context, directly generating individual attractors for each speaker. By combining these strengths, the speaker separation device according to this embodiment provides robust performance and generalization capability in separating mixture signals, even when the number of speakers is unknown.

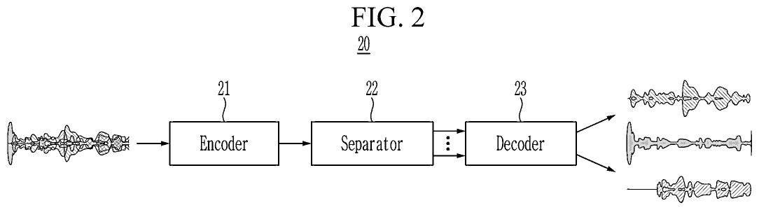

FIGS. 2 to 7 are diagrams for explaining implementation examples of the speaker separation device according to an embodiment.

Referring to FIG. 2, a speaker separation device 20 according to an embodiment may include an encoder-decoder separation model comprising an encoder 21, a separator 22, and a decoder 23. As shown, the mixture signal is input into the encoder 21, which maps the mixture signal into a latent representation and delivers it to the separator 22. The separator 22 receives the latent representation and performs speaker estimation for speaker separation. The decoder 23 outputs an audio signal for each source representation corresponding to the number of speakers separated by the separator 22.

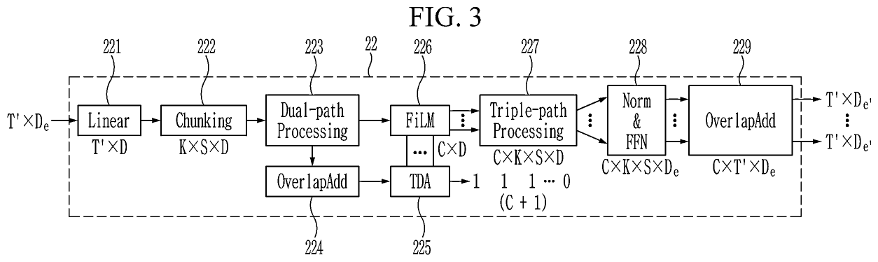

Referring to FIG. 3, the separator 22 may include several detailed components for performing speaker estimation. The speaker separation device 20 may use the linear layer 221 and chunking block 222 of the separator 22 to divide the output of the encoder 21 into multiple chunks. Additionally, the speaker separation device 20 may input the multiple chunks into the dual-path processing block 223 as a segmented tensor. In some embodiments, the multiple chunks may include S chunks (where S is a number determined by the file length), each having K frames (where K is an integer greater than or equal to 1).

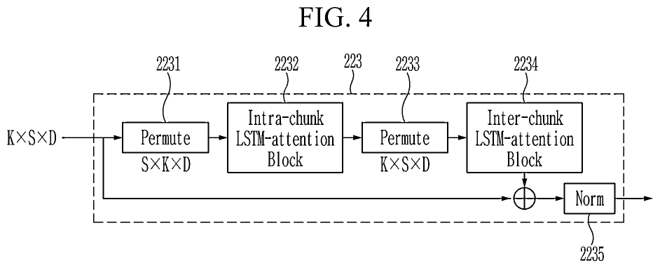

Referring also to FIG. 4, the dual-path processing block 223 may include an intra-chunk LSTM attention block 2232 for intra-chunk processing and an inter-chunk LSTM attention block 2234 for inter-chunk processing. Additionally, the dual-path processing block 223 may further include permutation blocks 2231 and 2233, a normalization layer 2235, and residual connections.

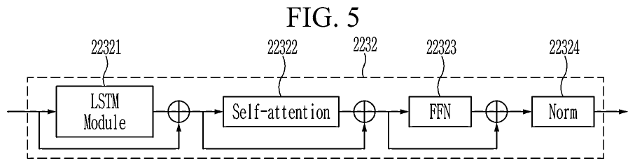

Referring also to FIG. 5, the intra-chunk LSTM attention block 2232 and the inter-chunk LSTM attention block 2234 may each include an LSTM module (Long Short-Term Memory) 22321 and a self-attention module 22322. Additionally, the intra-chunk LSTM attention block 2232 and the inter-chunk LSTM attention block 2234 may further include a feedforward layer 22323, a normalization layer 22324, and residual connections.

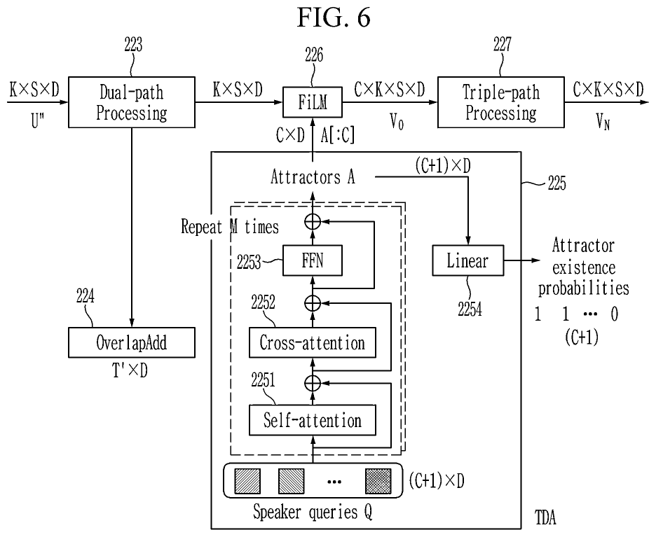

Referring also to FIG. 6, the speaker separation device 20 may input the output of the dual-path processing block 223 into the overlap-add block 224 to perform form restoration, and input the output of the overlap-add block 224 into the TDA calculation module 225 to extract a number of attractors A that is one more than the number of speakers. Additionally, the speaker separation device 20 may pass the attractors A through the linear layer 2254 of the TDA calculation module 225 to estimate the speaker existence probability. After estimating the speaker existence probability and excluding the attractors A determined not to correspond to any speaker, the speaker separation device 20 may input the attractors A into the FILM (Feature-wise Linear Modulation) module 226 to expand the speaker channels.

Here, the TDA calculation module 225 includes M transformer decoder layers (where M is an integer greater than or equal to 1), and each of the M transformer decoder layers may include a self-attention layer 2251 and a cross-attention layer 2252. The speaker separation device 20 may integrate the information between speaker queries Q through the self-attention layer 2251 of the transformer decoder layers, and integrate the information between the output of the dual-path processing block 223 and the speaker queries Q through the cross-attention layer 2252. Additionally, the TDA calculation module 225 may further include a feedforward layer 2253 and residual connections.

Referring again to FIG. 3, the speaker separation device 20 may refine the output of the FILM (Feature-wise Linear Modulation) module 226 through the triple-path processing block 227. The output of the triple-path processing block 227 may then be normalized and passed through the feedforward layer 228, after which it may be input into the overlap-add block 229 to perform form restoration.

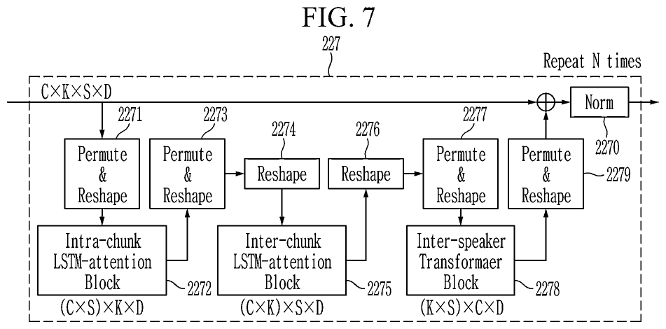

Referring also to FIG. 7, the triple-path processing block 227 may include an intra-chunk LSTM attention block 2272 for intra-chunk processing, an inter-chunk LSTM attention block 2275 for inter-chunk processing, and an inter-speaker transformer block 2278 for inter-speaker processing. Additionally, the triple-path processing block 227 may further include permutation and reshaping layers 2271, 2273, 2277, 2279, reshaping layers 2274, 2276, a normalization layer 2270, and residual connections.

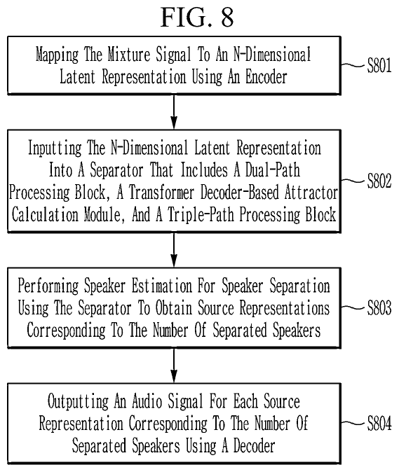

FIG. 8 is a flowchart for explaining a speaker separation method according to an embodiment.

Referring to FIG. 8, a speaker separation method according to an embodiment may include: mapping the mixture signal to an N-dimensional latent representation using an encoder (S801), inputting the N-dimensional latent representation into a separator that includes a dual-path processing block, a transformer decoder-based attractor calculation module, and a triple-path processing block (S802), performing speaker estimation for speaker separation using the separator to obtain source representations corresponding to the number of separated speakers (S803), and outputting an audio signal for each source representation corresponding to the number of separated speakers using a decoder (S804).

For more detail regarding the above method, reference can be made to the descriptions of other embodiments provided in this specification. Therefore, redundant content is omitted here.

FIG. 9 is a diagram for explaining a computing device according to an embodiment.

Referring to FIG. 9, the speaker separation method and device according to the embodiments may be implemented using a computing device 50. The computing device 50 may be implemented in various forms such as electronic devices, servers, or similar devices, and its functions may be realized through a combination of software and hardware.

The computing device 50 may include at least one of a processor 510, memory 530, user interface input device 540, user interface output device 550, and storage device 560, all of which communicate through a bus 520. The computing device 50 may also include a network interface 570, which is electrically connected to a network 40. The network interface 570 may transmit or receive signals to or from other entities through the network 40.

The processor 510 may be implemented as various types of computing units, such as an MCU (Micro Controller Unit), AP (Application Processor), CPU (Central Processing Unit), GPU (Graphic Processing Unit), NPU (Neural Processing Unit), or QPU (Quantum Processing Unit). The processor 510, as a semiconductor device that executes instructions stored in the memory 530 or storage device 560, may play a key role in the system. The program code and data stored in the memory 530 or storage device 560 instruct the processor 510 to perform specific tasks, enabling the overall operation of the system. Through this, the processor 510 may be configured to implement various functions and methods described earlier in relation to FIGS. 1 to 8.

The memory 530 and storage device 560 may include various types of volatile or non-volatile storage media for data storage and access in the system. For example, the memory 530 may include ROM (Read-Only Memory) 531 and RAM (Random Access Memory) 532. In some embodiments, the memory 530 may be embedded within the processor 510, allowing for very high data transfer speeds between the memory 530 and the processor 510. In other embodiments, the memory 530 may be located externally to the processor 510, and in this case, the memory 530 may be connected to the processor 510 via various data buses or interfaces. Such connections may be made using known methods, such as a PCIe (Peripheral Component Interconnect Express) interface or a memory controller for high-speed data transfer.

In some embodiments, at least a part of the configurations or functions of the speaker separation method and device according to the embodiments may be implemented as a program or software executed on the computing device 50. The program or software may be stored in a computer-readable recording medium or storage medium. Specifically, a computer-readable recording medium or storage medium according to an embodiment may contain a program that, when executed by a processor 510 included in a computer, such as the memory 530 or storage device 560, performs the steps involved in the implementation of the speaker separation method and device as described in the embodiments.

In some embodiments, at least a part of the configurations or functions of the speaker separation method and device according to the embodiments may be implemented using hardware or circuitry of the computing device 50, or as separate hardware or circuitry that may be electrically connected to the computing device 50.

According to the embodiments, given a small number of fixed, learned speaker queries and the mixture embedding generated by the dual-path processing block, the transformer decoder-based attractor (TDA) can infer the relationships between these queries and generate attractor vectors for each speaker. The estimated attractors are combined with the mixture embedding through feature-wise linear modulation conditioning to create the speaker dimension. The mixture embedding, conditioned by the speaker information generated by the TDA, is ultimately input into the triple-path processing block, which extends the dual-path processing block by adding an additional path dedicated to inter-speaker processing. In this manner, the speaker separation device can accurately separate an unknown number of speakers from a recorded mixture signal with high performance or correctly count the number of sources.

Although the embodiments of the present disclosure have been described in detail hereinabove, the scope of the present disclosure is not limited thereto. That is, various modifications and alterations made by those skilled in the art to which the present disclosure pertains by using a basic concept of the present disclosure as defined in the following claims also fall within the scope of the present disclosure.

What is claimed is:

1. A speaker separation method, performed by a computing device comprising a processor and a storage medium, for separating an unknown number of speakers from a recorded mixture signal based on an encoder-decoder separation model, the method comprising:
mapping, by the processor, the mixture signal to an N-dimensional latent representation (where N is an integer greater than or equal to 2) using an encoder of the encoder-decoder separation model;
inputting, by the processor, the N-dimensional latent representation into a separator of the encoder-decoder separation model, wherein the separator includes a dual-path processing block for modeling spectrotemporal patterns, a transformer decoder-based attractor (TDA) calculation module for handling an unknown number of speakers, and a triple-path processing block for modeling inter-speaker relations;
performing, by the processor, speaker estimation for speaker separation using the separator to obtain source representations corresponding to the number of separated speakers; and
outputting, by the processor, an audio signal for each source representation corresponding to the number of separated speakers using a decoder of the encoder-decoder separation model.

2. The speaker separation method of claim 1, wherein the encoder includes a one-dimensional convolutional layer with a kernel size of L samples (where L is an integer greater than or equal to 1) and a stride size of L/2 samples, and
wherein the mapping includes mapping, by the processor, the mixture signal to the N-dimensional latent representation using a Gaussian Error Linear Unit (GELU) activation function.

3. The speaker separation method of claim 1, wherein the performing speaker estimation comprises:
dividing, by the processor, the output of the encoder into multiple chunks using the linear layer and chunking block of the separator; and
inputting, by the processor, the multiple chunks into the dual-path processing block as a segmented tensor.

4. The speaker separation method of claim 3, wherein the multiple chunks comprise S chunks (where S is a number determined by the file length), each chunk having K frames (where K is an integer greater than or equal to 1).

5. The speaker separation method of claim 3, wherein the dual-path processing block comprises an intra-chunk LSTM attention block for intra-chunk processing and an inter-chunk LSTM attention block for inter-chunk processing, and
wherein the intra-chunk LSTM attention block and the inter-chunk LSTM attention block each comprise an LSTM module (Long Short-Term Memory) and a self-attention module.

6. The speaker separation method of claim 1, wherein the performing speaker estimation comprises:
inputting, by the processor, the output of the dual-path processing block into an overlap-add block to perform form restoration;
inputting, by the processor, the output of the overlap-add block into the TDA calculation module to extract a number of attractors that is one more than the number of speakers;
passing, by the processor, the attractors through the linear layer of the TDA calculation module to estimate the speaker existence probability; and
after excluding the attractors determined not to correspond to any speaker based on the speaker existence probability estimation, inputting, by the processor, the remaining attractors into a FILM (Feature-wise Linear Modulation) module to expand the speaker channels.

7. The speaker separation method of claim 6, wherein the TDA calculation module includes M transformer decoder layers (where M is an integer greater than or equal to 1), and wherein each of the M transformer decoder layers comprises a self-attention layer and a cross-attention layer.

8. The speaker separation method of claim 7, wherein the performing speaker estimation comprises:
integrating, by the processor, the information between speaker queries through the self-attention layer of the transformer decoder layers; and
integrating, by the processor, the information between the output of the dual-path processing block and the speaker queries through the cross-attention layer.

9. The speaker separation method of claim 6, wherein the performing speaker estimation comprises:
refining, by the processor, the output of the FILM (Feature-wise Linear Modulation) module through the triple-path processing block; and
inputting, by the processor, the output of the triple-path processing block into the overlap-add block to perform form restoration.

10. The speaker separation method of claim 9, wherein the triple-path processing block comprises:
an intra-chunk LSTM attention block for intra-chunk processing,
an inter-chunk LSTM attention block for inter-chunk processing, and
an inter-speaker transformer block for inter-speaker processing.

11. A speaker separation device, executing program code loaded into one or more memory devices through one or more processors, for separating an unknown number of speakers from a recorded mixture signal based on an encoder-decoder separation model, wherein the program code, when executed, performs:
mapping the mixture signal to an N-dimensional latent representation (where N is an integer greater than or equal to 2) using an encoder of the encoder-decoder separation model;
inputting the N-dimensional latent representation into a separator of the encoder-decoder separation model, wherein the separator includes a dual-path processing block for modeling spectrotemporal patterns, a transformer decoder-based attractor (TDA) calculation module for handling an unknown number of speakers, and a triple-path processing block for modeling inter-speaker relations;
performing speaker estimation for speaker separation using the separator to obtain source representations corresponding to the number of separated speakers; and
outputting an audio signal for each source representation corresponding to the number of separated speakers using a decoder of the encoder-decoder separation model.

12. The speaker separation device of claim 11, wherein the encoder includes a one-dimensional convolutional layer with a kernel size of L samples (where L is an integer greater than or equal to 1) and a stride size of L/2 samples, and
wherein the mapping includes mapping the mixture signal to the N-dimensional latent representation using a Gaussian Error Linear Unit (GELU) activation function.

13. The speaker separation device of claim 11, wherein the performing speaker estimation comprises:
dividing, by the processor, the output of the encoder into multiple chunks using the linear layer and chunking block of the separator; and
inputting, by the processor, the multiple chunks into the dual-path processing block as a segmented tensor.

14. The speaker separation device of claim 13, wherein the multiple chunks comprise S chunks (where S is a number determined by the file length), each chunk having K frames (where K is an integer greater than or equal to 1).

15. The speaker separation device of claim 13, wherein the dual-path processing block comprises an intra-chunk LSTM attention block for intra-chunk processing and an inter-chunk LSTM attention block for inter-chunk processing, and
wherein the intra-chunk LSTM attention block and the inter-chunk LSTM attention block each comprise an LSTM module (Long Short-Term Memory) and a self-attention module.

16. The speaker separation device of claim 11, wherein the performing speaker estimation comprises:
inputting, by the processor, the output of the dual-path processing block into an overlap-add block to perform form restoration;
inputting, by the processor, the output of the overlap-add block into the TDA calculation module to extract a number of attractors that is one more than the number of speakers;
passing, by the processor, the attractors through the linear layer of the TDA calculation module to estimate the speaker existence probability; and
after excluding the attractors determined not to correspond to any speaker based on the speaker existence probability estimation, inputting, by the processor, the remaining attractors into a FILM (Feature-wise Linear Modulation) module to expand the speaker channels.

17. The speaker separation device of claim 16, wherein the TDA calculation module includes M transformer decoder layers (where M is an integer greater than or equal to 1), and wherein each of the M transformer decoder layers comprises a self-attention layer and a cross-attention layer.

18. The speaker separation device of claim 17, wherein the performing speaker estimation comprises:
integrating, by the processor, the information between speaker queries through the self-attention layer of the transformer decoder layers; and
integrating, by the processor, the information between the output of the dual-path processing block and the speaker queries through the cross-attention layer.

19. The speaker separation device of claim 16, wherein the performing speaker estimation comprises:
refining, by the processor, the output of the FILM (Feature-wise Linear Modulation) module through the triple-path processing block; and
inputting, by the processor, the output of the triple-path processing block into the overlap-add block to perform form restoration.

20. The speaker separation device of claim 19, wherein the triple-path processing block comprises:
an intra-chunk LSTM attention block for intra-chunk processing,
an inter-chunk LSTM attention block for inter-chunk processing, and
an inter-speaker transformer block for inter-speaker processing.
